(19) United States
(12) Patent Application Publication
(10) Pub. No.: US 2019/0369594 A1
(43) Pub. Date: Dec. 5, 2019

(54) DIAGNOSIS DEVICE, DIAGNOSIS METHOD, AND DIAGNOSIS PROGRAM

(71) Applicant: FANUC CORPORATION, Yamanashi (JP)

(72) Inventors: Masao KAMIGUCHI, Yamanashi (JP); Noboru KUROKAMI, Yamanashi (JP); Shinichi OGAWA, Yamanashi (JP); Yuuya MIYAHARA, Yamanashi (JP); Yasushi OKAJIMA, Yamanashi (JP)

(21) Appl. No.: 16/396,962

(22) Filed: Apr. 29, 2019

(30) Foreign Application Priority Data
May 29, 2018 (JP) 2018-102392

(51) Int. Cl. G05B 19/406

(52) U.S. Cl. CPC G05B 19/406; G05B 2219/32222

(57) ABSTRACT

To provide a diagnosis device, a diagnosis method, and a diagnosis program capable of identifying a factor for defective machining. A diagnosis device comprises: a collection unit that collects machine data output during operation of a machine tool; a feature extraction unit that classifies the machine data according to an input factor for defective machining, and extracts a feature quantity from an aggregate of the machine data according to the input factor; and a determination unit that compares a feature quantity in the machine data output during actual machining by the machine tool with the feature quantity according to the factor, and determines a factor for defective machining based on a degree of match.

This application is based on and claims the benefit of priority from Japanese Patent Application No. 2018-102392, filed on 29 May 2018, the content of which is incorporated herein by reference.

### BACKGROUND OF THE INVENTION

### Field of the Invention

The present invention relates to a device, a method, and a program for diagnosing a machining state.

### Related Art

Various attempts have been made for reducing defects in machining. For example, patent document 1 suggests a technique of determining abnormality in machining by comparing a load torque pattern during normal machining and a load torque pattern during actual machining. Patent document 2 suggests a technique of determining abnormality in machining by generating master data from a load torque pattern and machining size data during normal machining, and comparing the master data and actual machining data.

Patent Document 1: Japanese Unexamined Patent Application, Publication No. 2000-84797

Patent Document 2: Japanese Unexamined Patent Application, Publication No. 2003-271212

### SUMMARY OF THE INVENTION

Examples of a factor for defective machining include a human factor such as start of machining with erroneous setting, a tool factor due to tool wear, a workpiece factor due to a defect in a workpiece material, a jig factor due to a defect in jig fixation, a machine factor due to wear or heat deformation of a machine, for example.

For example, machining is not performed correctly in the presence of a human factor such as erroneous setting, so that the machining should be stopped immediately. Regarding a tool factor, change of a tool can be delayed until the end of machining currently performed in response to a degree of wear. On an actual factory floor of machining, minimizing damage is important by taking different actions in response to defect factors, like in the foregoing cases. While defective machining has been found by detecting a motor load torque, etc. during actual machining according to the conventional technique, it has been impossible to identify a factor for the defective machining.

The present invention is intended to provide a diagnosis device, a diagnosis method, and a diagnosis program capable of identifying a factor for defective machining.

(1) A diagnosis device according to the present invention (diagnosis device 1 described later, for example) comprises: a collection unit (collection unit 101 described later, for example) that collects machine data output during operation of a machine tool (machine tool 2 described later, for example); a feature extraction unit (feature extraction unit 102 described later, for example) that classifies the machine data according to an input factor for defective machining, and extracts a feature quantity from an aggregate of the machine data according to the input factor; and a determination unit (determination unit 103 described later, for example) that compares a feature quantity in the machine data output during actual machining by the machine tool with the feature quantity according to the factor, and determines a factor for defective machining based on a degree of match.

(2) In the diagnosis device described in (1), the collection unit may further collect measured data resulting from measurement of a part machined by the machine tool, the feature extraction unit may classify the measured data according to the factor, and extract a feature quantity from an aggregate of the machine data and the measured data according to the factor, and the determination unit may compare a feature quantity in the machine data output during actual machining by the machine tool and the measured data after the machining with the feature quantity according to the factor, and determine a factor for defective machining based on a degree of match.

(3) In the diagnosis device described in (2), the machine data and the measured data may be associated with each other using a coordinate value determined during the machining.

(4) The diagnosis device described in any one of (1) to

(3) may comprise a signal converter (physical interface E described later, for example) that converts an electrical signal for transmission of data to be collected by the collection unit to a predetermined standard signal.

(5) The diagnosis device described in any one of (1) to (4) may comprise a data structure converter (software interface S described later, for example) that converts the structure of data to be collected by the collection unit to a predetermined standard format.

(6) The diagnosis device described in any one of (1) to (5) may comprise an output unit (output unit 104 described later, for example) that updates and outputs a result of the determination by the determination unit according to the factor together with the status of progress of the machining.

(7) In the diagnosis device described in any one of (1) to (5), the machine tool may include a plurality of machine tools, and the diagnosis device may comprise an output unit (output unit 104 described later, for example) that updates and outputs results of the determinations by the determination unit about the machine tools entirely together with the statuses of progress of the machining.

(8) A diagnosis method according to the present invention is executed by a computer (diagnosis device 1 described later, for example). The method comprises: a data collection step of collecting machine data output during operation of a machine tool (machine tool 2 described later, for example); a feature extraction step of classifying the machine data according to an input factor for defective machining, and extracting a feature quantity from an aggregate of the machine data according to the input factor; and a determination step of comparing a feature quantity in the machine data output during actual machining by the machine tool with the feature quantity according to the factor, and determining a factor for defective machining based on a degree of match.

(9) A diagnosis program according to the present invention is for causing a computer (diagnosis device 1 described for example) to execute: a data collection step of collecting machine data output during operation of a machine tool (machine tool 2 described later, for example); a feature extraction step of classifying the machine data according to an input factor for defective machining, and extracting a feature quantity from an aggregate of the machine data according to the input factor; and a determination step of comparing a feature quantity in the machine data output during actual machining by the machine tool with the feature quantity according to the factor, and determining a factor for defective machining based on a degree of match.

The present invention achieves identification of a factor for defective machining.

### BRIEF DESCRIPTION OF THE DRAWINGS

FIG. 1 is a block diagram showing the functional configuration of a diagnosis device according to an embodiment;

FIG. 2 is a block diagram snowing the configuration of principal functions provided in a controller of a machine tool according to the embodiment;

FIG. 3 is a block diagram showing the configuration of principal functions provided in a controller of a measuring instrument according to the embodiment;

FIG. 4 shows an example of an input screen for an inspection result containing factors for defective machining according to the embodiment;

FIG. 5 shows an exemplary structure of a database stored in a storage unit according to the embodiment.;

FIG. 6 shows an example of measured data used in a diagnosis method according to the embodiment;

FIG. 7 shows an example of a display screen for a diagnosis result according to the embodiment; and

FIG. 8 shows an example of a monitoring screen containing a diagnosis result according to the embodiment.

### DETAILED DESCRIPTION OF THE INVENTION

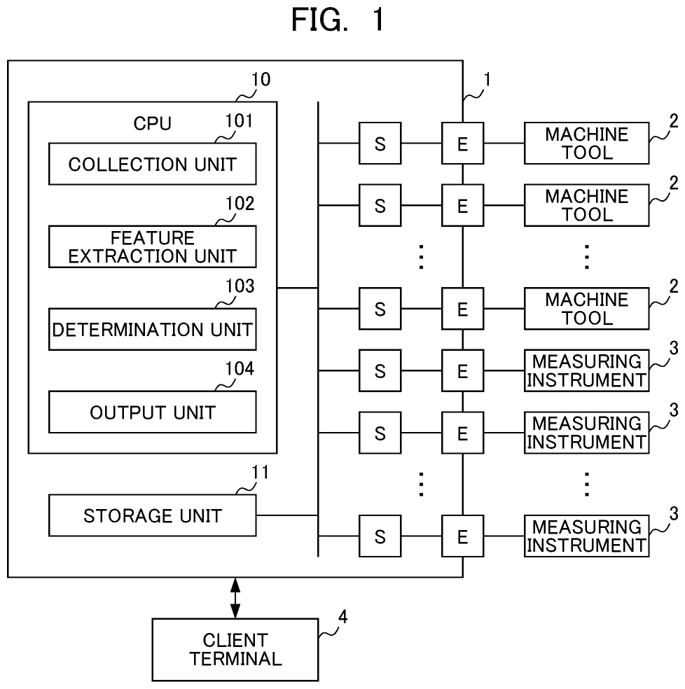

An example of an embodiment of the present invention will be described next. FIG. 1 is a block diagram showing the functional configuration of a diagnosis device 1 according to the embodiment. The diagnosis device 1 is connectable to at least one machine tool 2 and at least one measuring instrument. 3.

The diagnosis device 1 is an information processor (computer) such as a personal computer or a server device, and includes a CPU 10 as a control unit, a storage unit 11, and various types of input/output devices and a communication interface.

For connection to the multiple machine tools 2 or multiple measuring instruments 3, the diagnosis device I includes a physical interface E as a signal converter conforming to a connector and electrical specifications employed in each of these machines. An electrical signal transmitted from each of the machines through the physical interface E is converted to a predetermined standard signal. For example, Ethernet may be used as a normal communication standard. The physical interface E may be an external interface.

The diagnosis device 1 includes a software interface S as a data structure converter that converts the structure of data obtained from an electrical signal input through the physical interface E to a predetermined standard format. The CPU 10 may take the place of the software interface S for the conversion of the data format. The data structure converter includes a mechanism for conversion of differences between protocols such as Ethernet/IP, EtherCAT and OPC, and a software module for adjusting unit systems of data having the same meaning or collecting data having the same meaning among data acquired through communication.

The physical interface E and the software interface S are bidirectionally convertible. The diagnosis device 1 may feed back information and a diagnosis result about machining to the machine tool 2, and the machine tool 2 may compensate for the machining in response to the diagnosis result. The measuring instrument 3 may acquire information about measurement and information about a measurement result from the diagnosis device 1, and may reflect the acquired information in a measurement method.

The CPU 10 includes a collection unit 101, a feature extraction unit 102, a determination unit 103, and an output unit 104. These functional units are realized by execution of a diagnosis program in the storage unit 11 by the CPU 10.

The collection unit 101 collects machine data from the machine tool 2 through the physical interface E and the software interface S together with sampling time. The collected machine data is data output during operation of the machine tool 2. The collection unit 101 further collects measured data from the measuring instrument 3 through the physical interface E and the software interface S. The collected measured data is data resulting from measurement of a part machined by the machine tool 2. At this time, the machine data in each sampling time and the measured data are associated with each other using a coordinate value determined during machining, and then stored into the storage unit 11.

The feature extraction unit 102 classifies the collected machine data and measured data according to a factor for defective machining input separately from a user, and extracts a feature quantity from an aggregate of the machine data and the measured data according to the input factor.

The determination unit 103 compares a feature quantity in the machine data output during actual machining the machine tool 2 and measured data after the machining with the feature quantity according to the factor, and determines a factor for defective machining based on a degree of match.

The output unit 104 updates and outputs a result of the determination by the determination unit 103 according to the factor together with the status of progress of the machining by the machine tool 2. The output unit 104 may update and output results of the determinations by the determination unit 103 about the multiple machine tools 2 entirely together with the statuses of progress of the machining. The output data is transmitted through the communication interface of the diagnosis device 1 to a client terminal 4.

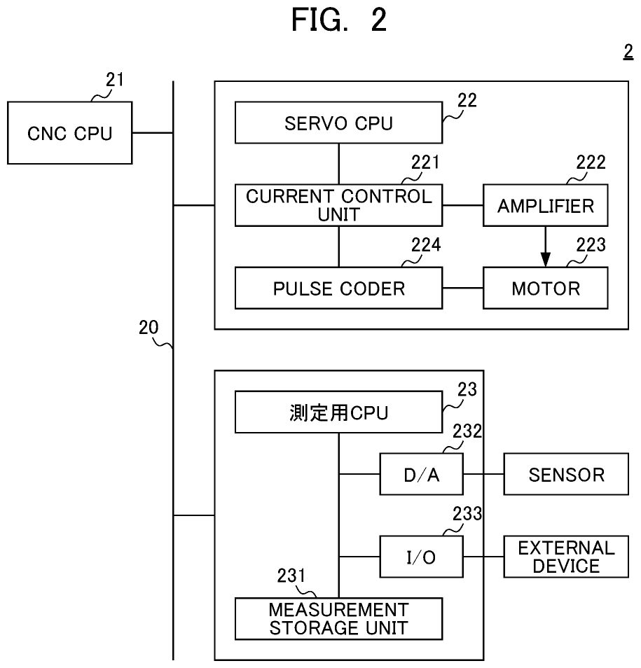

FIG. 2 is a block diagram showing the configuration of principal functions provided in a controller of the machine tool 2 according to the embodiment. The machine tool 2 includes a computerized numerical control (CNC) CPU 21 for controlling a machining path, and a servo CPU 22. The servo CPU 22 gives a command to a current control unit. 221, and controls a servo motor 223 through an amplifier 222.

The machine tool 2 includes a measurement. CPU 23 that operates in the same cycle as the servo CPU 22 for data collection with intervention of a high-speed bus 20. As the measurement CPU 23 operates in the same cycle as the servo CPU 22, the measurement CPU 23 is allowed to collect position data, speed command data, current data, position feedback data measured by a pulse coder 224 provided for the motor 223, disturbance load torque data calculated by the servo CPU 22, etc. in synchronization with the operating cycle of the servo CPU 22. The collected data is accumulated in a measurement storage unit 231 together with sampling time.

The measurement CPU 23 includes a digit analog converter 232 and an input/output interface 233. The measurement CPU 23 can capture a signal from an external sensor and information from an external device in synchronization with the operating cycle of the servo CPU 22. The functional units including the measurement CPU 23 may be provided in the controller of the machine tool 2, or may be connected as unitized functional units externally to the machine tool 2.

The illustration in FIG. 2 corresponds to one servo motor configuration. Meanwhile, the controller may include multiple servo motor configurations in response to a purpose of machine use. Alternatively, data about multiple servo motor configurations may be measured by one measurement CPU 23, or the measurement CPU 23 may be attached to each servo motor configuration.

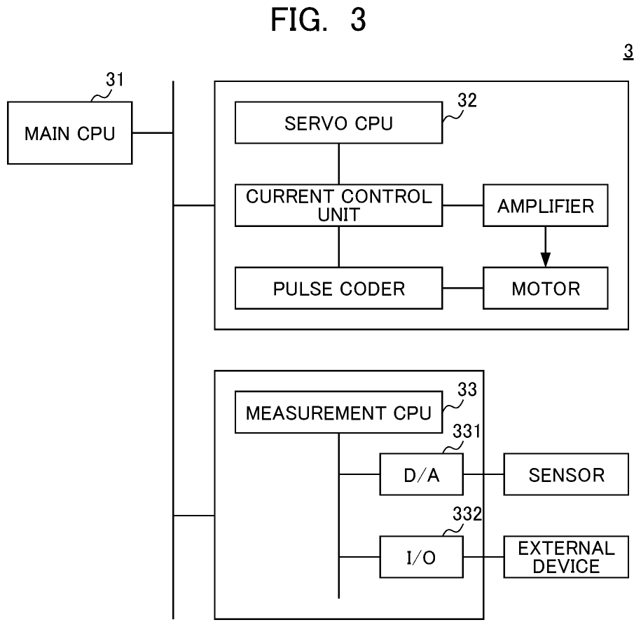

FIG. 3 is a block diagram showing the configuration of principal functions provided in a controller of the measuring instrument 3 according to the embodiment. The measuring instrument 3, which may be a three-dimensional measuring instrument, includes a main CPU 31 for overall control. Like the machine tool 2, the measuring instrument 3 further includes a servo CPU 32 for controlling a mechanism to operate in space. The measuring instrument 3 includes a measurement CPU 33 for data collection. The measuring instrument 3 may further include a digital/analog converter 331 for acquisition of data from a non-contact sensor, and an input/output interface 332 for input and output to and from an external device, for example.

The illustration in FIG. 3 corresponds to one servo motor configuration. Meanwhile, the controller may include multiple servo motor configurations in response to a purpose of machine use. Alternatively, da to about multiple servo motor configurations may be measured by one measurement CPU 33, or the measurement CPU 33 may be attached to each servo motor configuration.

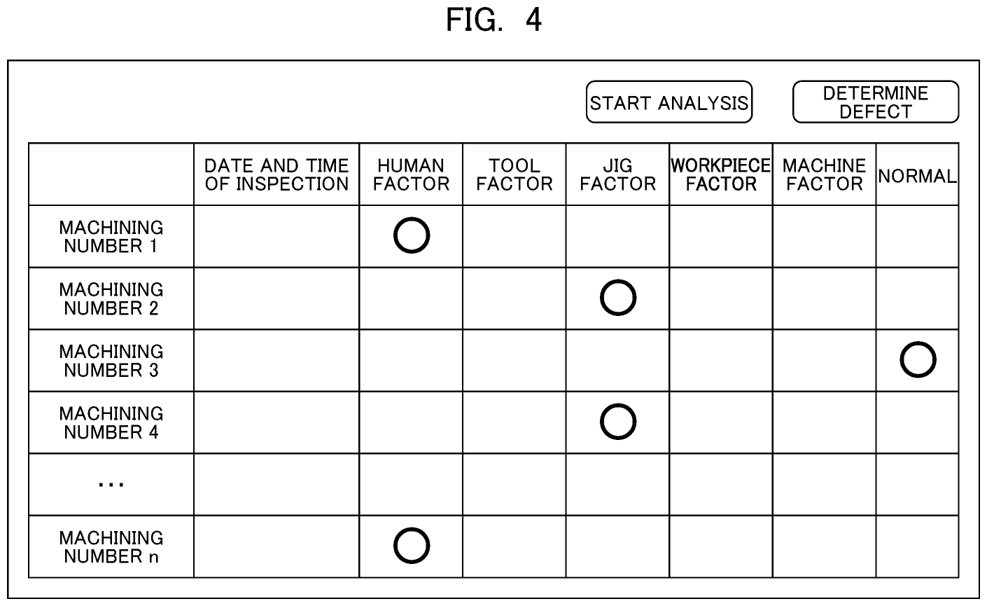

FIG. 4 shows an example of an input screen for an inspection result containing factors for defective machining according to the embodiment. This input screen is displayed on the diagnosis device 1 or the client terminal 4. This input screen is used for inputting a result of inspection of a machined part by an inspector using a measuring instrument, for example, at the time of end of each machining. For example, the date and time of inspection, the presence or absence of defective machining, and a factor for defective machining are input in association with each machining accomplishment identified by a machining number. The input data is linked with machine data and measured data using the machining number as a key, and then stored into the storage unit 11.

In some cases, machined parts are subjected to sampling inspection, not total inspection. In the case of sampling inspection, not only machine data corresponding to a machining accomplishment targeted for inspection but also machine data not targeted for actual inspection may be stored in association with an inspection result and measured data.

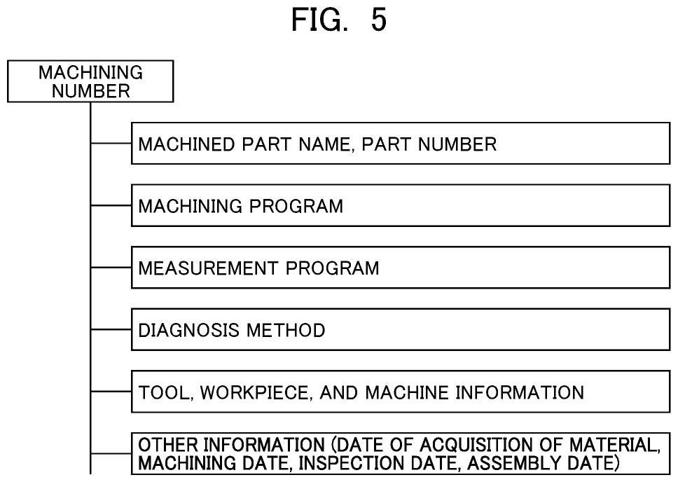

FIG. 5 shows an exemplary structure of a database stored in the storage unit 11 according to the embodiment. In the field of machining, it generally requires time to measurement and inspection after the machining to make it difficult to ensure traceability in a factory. In the embodiment, a machining number is used for identifying each machining accomplishment. In addition to being used for identifying a machining accomplishment about a part, a machining number is used in the form of an electronic tag, for example, for managing assembly after machining, managing a finished part, and managing a product after shipment.

The database contains the following information stored in linking relationship with a machining number: a machined part name and a part number, a machining program, a measurement program, a diagnosis method, information about a tool to be used, and about a workpiece and a machine, and other types of information such as a date of acquisition of a material, a machining date, an inspection date, an assembly date, etc.

An analysis function fulfilled by the feature extraction unit 102 of the diagnosis device 1 is available through an input screen on the client terminal 4. If “start analysis” on the screen is selected, for example, the feature extraction unit 102 extracts a feature quantity from data accumulated in a data area of each factor according to a factor for defective machining set by a machining number, and stores the extracted feature quantity as a feature quantity about each factor into the storage unit 11.

A defect determination function fulfilled by the determination unit 103 of the diagnosis device 1 is available through an input screen on the client terminal 4. “determine defect” on the screen is selected, for example, the determination unit 103 compares a feature quantity stored according to a factor for defective machining with machine data and measured data transmitted during machining and during measurement respectively, and determines a defect factor having a high degree of match. A result of this determination is transmitted to the client terminal 4 and displayed on the screen.

Factors for defective machining are classified into a human factor, a tool factor, a jig factor, a workpiece factor, and a machine factor, for example. The human factor includes erroneous setting of offset data, for example. The erroneous setting of the offset data causes unintentional change in a machined amount. Hence, it becomes necessary to stop machining immediately at some positions and perform machining again after correction of the setting.

The tool factor relates to wear of a tool. If there is lack of cutting oil or if a machining speed is high, load on the tool increases to facilitate wear of the tool. If the wear of the tool within a tolerance range of machine accuracy, action such as change of the tool can be taken before next machining. The tool factor may be determined based on the occurrence of abnormal noise or vibration during machining or poor accuracy of an entire machined object, for example.

The jig factor relates to defective fixation of a workpiece or trouble at a driver of a jig. The jig factor may be determined based on the occurrence of abnormal noise during machining or poor accuracy of a machined object in terms of a direction in which the jig is attached, for example.

The workpiece factor may be the presence of a blowhole in a casting, for example, and may be checked by visual inspection.

The machine factor includes wear of a ball screw or a bearing of a drive axis, or that of a linear guide, for example. The machine factor may be determined based on poor machine accuracy at a worn part in the direction of the drive axis.

The following describes a particular example of a method of diagnosing a feature quantity according to a factor for defective machining in machine data and measured data and diagnosing a machining status.

### [Collected Machine Data]

The collection unit 101 acquires machine data about an actual operating status of the machine tool 2 in a predetermined sampling cycle together with temporal information. The machine data is motor control data about a spindle and a feed axis, for example. The machine data includes a command value and an actually measured value about a current or a voltage, a command value and an actually measured value about a position (coordinate value), position feedback data, a command value and an actually measured value about a speed, a command value and an actually measured value about a torque, etc.

[Feature Quantity Extracted from Machine Data]

For example, time-series data in a predetermined sampling period including an actually measured value about a load torque, an effective current, and an actually measured value about a position regarding a machining accomplishment determined to be defective machining is compared with time-series data including the same type of data in a normal period. A statistical value such as a maximum, a minimum, an average, or the sum of squares is extracted as a feature quantity according to a factor from an aggregate of deviations as a result of the comparison.

For example, the following feature quantities are estimated according to corresponding factors. In the case of a human factor, a deviation relating to an actually measured value about a position differs from those of the other factors. In the case of a tool factor, a deviation relating to an actually measured value about a load torque differs from those of the other factors. In the case of a jig factor, a deviation relating to an actually measured value about a position in a direction of attachment differs from those of the other factors. In the case of a workpiece factor, an actually measured value about a load torque during cutting changes momentarily in response to the size of a blowhole in a casting. In the case of a machine factor, a deviation relating to an actually measured value about a position in a direction of a drive axis differs from those of the other factors.

### [Collected Measured Data]

The collection unit 101 collects position data contained in measured data about a machining size at predetermined measurement intervals. At this time, machine data in each sampling time during machining and measured data at measurement intervals after the machining are associated with each other using actually measured values or representative values (such as command values or theoretical values) about positions in the machine data and the measured data, for example. By doing so, position information pieces synchronized in a predetermined measurement zone are acquired both from the machine data and the measured data.

[Feature Quantity Extracted from Measured Data]

For example, position data in measured data about a machining size in each predetermined measurement interval regarding a machining accomplishment determined to be defective machining is compared with a representative value (a theoretical value, an average, or a center value of tolerance, for example) of position data including the same type of data in a normal period. A statistical value such as a maximum, a minimum, an average, or the sum of squares is extracted as a feature quantity according to a factor from an aggregate of deviations as a result of the comparison.

### [Combined Feature Quantity]

As described above, the machine data and the measured data are associated with each other. A feature quantity about a position is extracted from the machine data, and a feature quantity about the same position is extracted from the measured data. These extracted feature quantities may be combined to calculate an integrated feature quantity. For example, the machine data and the measured data may be used as continuous data about each stroke in space, and may be subjected to principal component analysis. A defect factor is analyzed through the principal component analysis in factor space defined by the motion of the measured data and the motion of the machine data to acquire factor space indicating a feature quantity according to the defect factor.

### [Method of Diagnosing Machining Status]

A threshold for an extracted feature quantity is set according to a factor for defective machining. If a statistical value exceeding or falling below the set threshold is obtained from machine data acquired during machining, or from machine data or measured data acquired after the machining, the determination unit 103 determines that a machining status is abnormal and defective machining has occurred, and determines a factor for the defective machining.

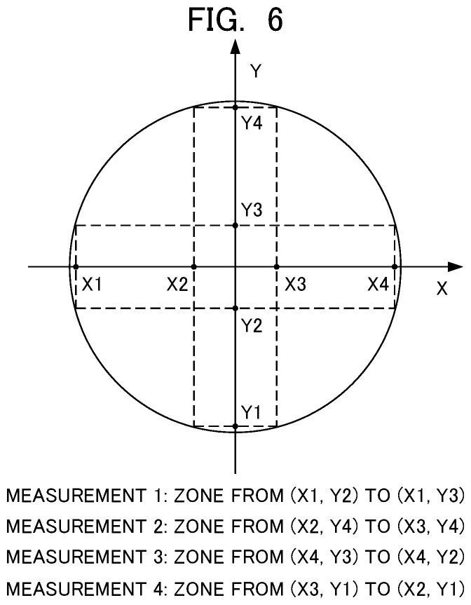

FIG. 6 shows an example of measured data used in the diagnosis method according to the embodiment. Items of inspection by the measuring instrument 3 are generally determined in a design stage. For three-dimensional machining, by determining a machining start zero point and an inspection zero point, a coordinate system of a workpiece before the machining and a coordinate system of the workpiece after the machining are managed in association with each other.

FIG. 6 shows an example of measurement of circularity of a part. A defect in the circularity includes a protrusion occurring when the rotary direction of a ball screw is reversed. For such machining, inspection along an entire circumference is not required but inspection is made only in a zone near a position of the occurrence of the protrusion (four zones in FIG. 6, for example). By doing so, inspection time is shortened.

A feature quantity according to a factor for defective machining may be extracted from machine data or measured data by a method using principal component analysis. For example, measured data is defined as a first principal component in this case, changes in data to become second, third, . . . , n-th principal components may be determined as feature quantities. Alternatively, a feature quantity may be tendency of change from a center value (upward tendency or downward tendency) or a natural frequency obtained from the fast Fourier transform (FFT), for example. A factor for defective machining is determined based on a degree of match between such a feature quantity and the collected machine data and measured data.

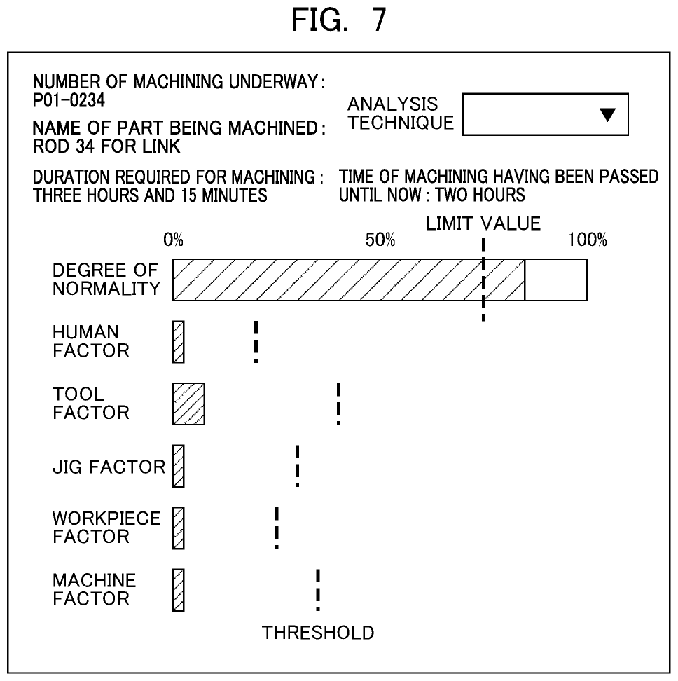

FIG. 7 shows an example of a display screen for a diagnosis result according to the embodiment. In this example, the name of a part being machined, a duration required for machining, and time of the machining having been passed until now are displayed together with a machining number. Further, a degree of normality and a determination status according to a factor for defective machining are displayed as a current result of diagnosis.

A degree of normality shows a ratio of parts having been machined normally without being determined to result from defective machining relative to entire machining accomplishments, or a ratio of the number of times when determinations as being normal have been made during an analysis period. A limit value is set for this degree of normality. If the degree of normality falls below the limit value, a warning is output.

A determination status according to a factor shows a ratio of parts determined to result from defective machining, or a ratio of the number of times when determinations as being defective have been made during an analysis period. A threshold common to factors or a threshold for each factor is set for this determination status according to a factor. If the determination status exceeds the threshold, a warning is output.

A technique of analyzing defective machining may be selected. For example, the analysis technique is selected from options “1. Principal component analysis, 2. FFT, 3. Tendency analysis, and 4. Combination.” If the combination is selected, the diagnosis device 1 accepts designation of numbers such as “1+2+3,” and displays a result obtained by each analysis technique or a result obtained by combining multiple analysis techniques.

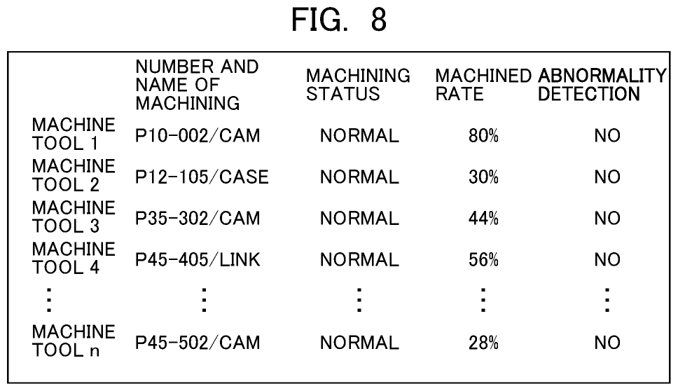

FIG. 8 shows an example of a monitoring screen containing a diagnosis result according to the embodiment. In this example, the following items are displayed in relation to each of the machine tools 2 in an entire factory: the number and name of machining, a machining status indicating whether the machining proceeds normally, a progress rate of the machining, and the presence or absence of abnormality detection. Display items are not limited to these. Various types of data in addition to the diagnosis result illustrated in FIG. 7 can be displayed.

According to the embodiment, the diagnosis device 1 extracts a feature quantity from machine data collected according to a factor for defective machining, and compares the extracted feature quantity with a feature quantity in the machine data during machining, thereby determining a factor for defective machining based on a degree of match. This allows the diagnosis device 1 to easily identify the factor for the defective machining through comparison with a machining accomplishment in the past. As a result, the defective machining can be found at an early stage and action responsive to each factor can be taken efficiently, thereby increasing machining efficiency.

The diagnosis device 1 collects measured data obtained by the measuring instrument 3 in addition to the machine data, and extracts a feature quantity according to a factor for defective machining. In this way, the measured data is used for determination of a factor. This allows the diagnosis device 1 to make a determination with a higher degree of accuracy based on more information. For this determination, the diagnosis device 1 associates the machine data and the measured data using a coordinate value determined during machining, making it possible to increase determination accuracy with the machine data and the measured data correctly associated with each other.

The diagnosis device 1 collects the machine data and the measured data through conversion of an electrical signal to a standard signal. This achieves handling of signals of respective specifications in the same way input from the multiple machine tools 2 and the multiple measuring instruments 3 to allow efficient collection of various types of data. Further, the diagnosis device 1 converts the structure of data to be collected to a standard format. This achieves handling of data of respective formats in the same way to allow efficient collection of various types of data.

The diagnosis device 1 updates and outputs the presence or absence of defective machining and a determination result about a factor according to a factor for the defective machining together with the status of progress of machining. This allows a user to find abnormality at an early stage occurring during the machining and to identify the factor for the defective machining easily.

The diagnosis device 1 updates a determination result about each of the multiple machine tools 2 together with the status of progress of machining, and outputs the results in a list form. This allows the user to monitor a machining status in an entire factor easily, making it possible to find the occurrence of defective machining efficiently.

While the embodiment, of the present invention has been described above, the present invention should not be limited to the foregoing embodiment. The effects described in the embodiment are merely a list of the most preferable effects resulting from the present invention. Effects achieved by the present invention should not be limited to those described in the embodiment.

The diagnosis device 1 may be connected to the multiple machine tools 2 and the multiple measuring instruments 3 through a network. The functional units of the diagnosis device 1 such as the feature extraction unit 102 or the determination unit 103 may be distributed to multiple devices on the network. The analysis function fulfilled by the feature extraction unit 102 and the determination unit 103 may include multiple analysis functions responsive to analysis techniques, and may be distributed to multiple devices. In this case, the multiple analysis functions are used selectively, and an analysis result is provided to the client terminal 4.

The diagnosis method executed by the diagnosis device 1 is realized by software. To realize the diagnosis method by software, programs constituting the software are installed on a computer (diagnosis device 1). These programs may be stored in a removable medium and distributed to a user. Alternatively, these programs may be distributed by being downloaded to a computer of the user through a network.

### EXPLANATION OF REFERENCE NUMERALS

E Physical interface (signal converter)

S Software interface (data structure converter)

1 Diagnosis device

2 Machine tool

3 Measuring instrument

4 Client terminal

10 CPU

11 Storage unit

101 Collection unit

102 Feature extraction unit

103 Determination unit

104 Output unit

What is claimed is:

1. A diagnosis device comprising:
a collection unit that collects machine data output during operation of a machine tool;
a feature extraction unit that classifies the machine data according to an input factor for defective machining, and extracts a feature quantity from an aggregate of the machine data according to the input factor; and
a determination unit that compares a feature quantity in the machine data output during actual machining by the machine tool with the feature quantity according to the factor, and determines a factor for defective machining based on a degree of match.

2. The diagnosis device according to claim. 1, wherein
the collection unit further collects measured data resulting from measurement of a part machined by the machine tool,
the feature extraction unit classifies the measured data according to the factor, and extracts a feature quantity from an aggregate of the machine data and the measured data according to the factor, and
the determination unit compares a feature quantity in the machine data output during actual machining by the machine tool and the measured data after the machining with the feature quantity according to the factor, and determines a factor for defective machining based on a degree of match.

3. The diagnosis device according to claim 2, wherein
the machine data and the measured data are associated with each other using a coordinate value determined during the machining.

4. The diagnosis device according to claim 1, comprising
a signal converter that converts an electrical signal for transmission of data to be collected by the collection unit to a predetermined standard signal.

5. The diagnosis device according to claim 1, comprising
a data structure converter that converts the structure of data to be collected by the collection unit to a predetermined standard format.

6. The diagnosis device according to claim 1, comprising
an output unit that updates and outputs a result of the determination by the determination unit according to the factor together with the status of progress of the machining.

7. The diagnosis device according to claim 1, wherein
the machine tool includes a plurality of machine tools, and the diagnosis device comprises an output unit that updates and outputs results of the determinations by the determination unit about the machine tools entirely together with the statuses of progress of the machining.

8. A diagnosis method executed by a computer comprising:
a data collection step of collecting machine data output during operation of a machine tool;
a feature extraction step of classifying the machine data according to an input factor for defective machining, and extracting a feature quantity from an aggregate of the machine data according to the input factor; and
a determination step of comparing a feature quantity in the machine data output during actual machining by the machine tool with the feature quantity according to the factor, and determining a factor for defective machining based on a degree of match.

9. A non-transitory computer-readable medium storing a diagnosis program for causing a computer to execute:
a data collection step of collecting machine data output during operation of a machine tool;
a feature extraction step of classifying the machine data according to an input factor for defective machining, and extracting a feature quantity from an aggregate of the machine data according to the input factor; and
a determination step of comparing a feature quantity in the machine data output during actual machining by the machine tool with the feature quantity according to the factor, and determining a factor for defective machining based on a degree of match.
